(19) United States
(12) Patent Application Publication
(10) Pub. No.: US 2024/0128484 A1
(43) Pub. Date: Apr. 18, 2024

(54) FUEL CELL SYSTEM AND METHOD OF CONTROLLING THE SAME

(71) Applicants: HYUNDAI MOTOR COMPANY, Seoul (KR); KIA CORPORATION, Seoul (KR)

(72) Inventors: Ji Hoon Ryu, Seoul (KR); Jae Sung Ryu, Seoul (KR); Jong Hyun Lee, Yongin-si (KR); Yei Sik Jeon, Seoul (KR); Young Wook Cheong, Seoul (KR)

(73) Assignees: HYUNDAI MOTOR COMPANY, Seoul (KR); KIA CORPORATION, Seoul (KR)

(21) Appl. No.: 18/136,176

(22) Filed: Apr. 18, 2023

(30) Foreign Application Priority Data
Oct. 14, 2022 (KR) 10-2022-0132489

(51) Int. Cl. H01M 8/04858; H01M 8/04089; H01M 8/04228; H01M 8/0438; H01M 8/0444; H01M 8/04537; H01M 16/00

(52) U.S. Cl. CPC H01M 8/04953; H01M 8/04097; H01M 8/04228; H01M 8/04388; H01M 8/04447; H01M 8/04559; H01M 16/006; H01M 2008/1095

(57) ABSTRACT

A fuel cell system and a method of controlling the system are provided. The fuel cell system includes: a fuel cell having a plurality of cells to generate power through a reaction between hydrogen supplied to an anode space and oxygen supplied to a cathode space; a power storage device to be charged with power generated by the fuel cell or discharged to supply power; and a controller. The controller recirculates hydrogen, diffused from the anode space to the cathode space, into the anode space by supplying power charged in the power storage device to the fuel cell when the power generation of the fuel cell is stopped. The controller is configured to control whether to supply the power to the fuel cell based on a pressure measured in the anode space and voltages of the cells that constitute the fuel cell.

### CROSS REFERENCE TO RELATED APPLICATION

The present application claims priority to Korean Patent Application No. 10-2022-0132489 filed on Oct. 14, 2022, the entire contents of which are incorporated herein for all purposes by this reference.

### BACKGROUND

### Field of the Disclosure

The present disclosure relates to a fuel cell system and a method of controlling the same. More particularly, the present disclosure relates to a fuel cell system and a method of controlling the same, which control whether to supply power to a fuel cell and prevent a problem that may occur in a hydrogen abundance situation or a hydrogen deficiency situation in a cathode space in an electrochemical hydrogen pumping (EHP) reaction section.

### Description of the Related Art

A fuel cell system is a system that converts chemical energy into electrical energy by using an oxidation-reduction (redox) reaction of hydrogen and oxygen respectively supplied from a hydrogen supply device and an air supply device. The fuel cell system includes a fuel cell for producing electrical energy and a cooling system for cooling the fuel cell.

Hydrogen is supplied to an anode of the fuel cell. In the anode, an oxidation reaction of hydrogen is performed, resulting in generating hydrogen ions (protons) and electrons. The hydrogen ions and electrons generated in the anode move to a cathode through an electrolyte membrane and an outer conductive wire, respectively. In the cathode, the hydrogen ions and electrons moved from the anode have an electrochemical reaction with oxygen in the air, thereby generating electrical energy.

A crossover phenomenon in which gas passes through the electrolyte membrane by diffusion caused by a partial pressure difference of the gas occurs inside the fuel cell. In particular, in a state in which the fuel cell stops generating power, the supply of air to the cathode is cut off, and the crossover hydrogen is moved from the anode to the cathode. For this reason, there is a problem in that the crossover hydrogen is discharged to the outside through an air processing line when the fuel cell resumes the power generation and air is supplied to the cathode.

When hydrogen with high concentration is discharged to the outside, hydrogen may combust when static electricity or sparks occur nearby. In addition, the concentration of hydrogen in discharged gas may not satisfy relevant laws and regulations.

In order to solve the above-mentioned problems, the following method has been used. A controller pumps the hydrogen ions into the anode space through an electrochemical hydrogen pumping (EHP) reaction and recombines the pumped hydrogen ions into hydrogen molecules H2. The concentration of hydrogen is thereby reduced in the gas discharged to the outside.

However, the pressure in the anode space may excessively increase when hydrogen is pumped in a state in which an excessive amount of hydrogen remains in the cathode space. In addition, when hydrogen is pumped in a state in which the hydrogen remaining in the cathode space is deficient, a high potential phenomenon is caused by hydrogen pumping. As a result, there is a problem in that the likelihood of deterioration of the fuel cell increases.

The foregoing explained as the background is intended merely to aid in understanding the background of the present disclosure. The foregoing is not intended to mean that the present disclosure falls within the purview of the related art that is already known to those having ordinary skill in the art.

### SUMMARY

Accordingly, the present disclosure has been made keeping in mind the above problems occurring in the related art. The present disclosure is intended to provide a fuel cell system and a method of controlling the same, which control whether to supply power to a fuel cell and prevent a problem that may occur in a cathode hydrogen abundance or deficiency situation in an electrochemical hydrogen pumping (EHP) reaction section.

According to one aspect, a fuel cell system is provided and includes: a fuel cell having a plurality of cells and configured to generate power through a reaction between hydrogen supplied to an anode space and oxygen supplied to a cathode space; a power storage device configured to be charged with power generated by the fuel cell or discharged to supply power; and a controller. The controller is configured to recirculate hydrogen, which has been diffused from the anode space to the cathode space, into the anode space by supplying power, which is charged in the power storage device, to the fuel cell in a state in which the power generation of the fuel cell is stopped. The controller is also configured to control whether to supply the power charged in the power storage device to the fuel cell based on a pressure measured in the anode space and voltages of the cells that constitute the fuel cell.

For example, the controller may measure a pressure in the anode space based on a gas concentration in the anode space.

For example, the controller may perform control to cut off the supply of power to the fuel cell when the pressure in the anode space exceeds a first reference value.

For example, the controller may measure the voltage of the cell constituting the fuel cell based on a concentration of hydrogen in the cathode space.

For example, the controller may perform control to cut off the supply of power to the fuel cell when a maximum voltage of at least one of the cells constituting the fuel cell exceeds a second reference value.

For example, the controller may perform control to cut off the supply of power to the fuel cell when a minimum voltage of all the cells constituting the fuel cell exceeds a third reference value.

For example, the controller may perform control to cut off the supply of power to the fuel cell when an average voltage of the cells constituting the fuel cell exceeds a fourth reference value.

For example, the controller may perform control to supply hydrogen to the anode space based on an initial hydrogen pressure in the anode space, before the power generation of the fuel cell is stopped.

For example, the controller may perform control to supply hydrogen to the anode space based on a hydrogen pressure in the anode space immediately after the supply of power to the fuel cell is cut off, after the supply of power to the fuel cell is cut off.

For example, the controller may measure a concentration of hydrogen in the anode space based on the number of moles of hydrogen recirculated in the anode space, the initial number of moles of hydrogen in the anode space, and the number of moles of hydrogen supplied in the anode space before the power generation of the fuel cell is stopped and after the supply of power to the fuel cell is cut off. The controller may determine the number of times of purging hydrogen, i.e., the number of times hydrogen is purged, based on the measured concentration of hydrogen in the anode space.

According to one aspect, a method of controlling a fuel cell system is provided. The fuel cell system includes a fuel cell having a plurality of cells and configured to generate power through a reaction between hydrogen supplied to an anode space and oxygen supplied to a cathode space. The fuel cell system also includes a power storage device configured to be charged with power generated by the fuel cell or discharged to supply power. The method includes: supplying, by a controller, power charged in the power storage device to the fuel cell in a state in which the power generation of the fuel cell is stopped; recirculating, by the controller, hydrogen, which has been diffused from the anode space to the cathode space, into the anode space; and controlling, by the controller, whether to supply power charged in the power storage device to the fuel cell based on a pressure in the anode space and voltages of the cells that constitute the fuel cell.

For example, the controlling of whether to supply power to the fuel cell may include cutting off the supply of power to the fuel cell when a pressure in the anode space exceeds a first reference value.

For example, the controlling of whether to supply power to the fuel cell may include cutting off the supply of power to the fuel cell when a maximum voltage of at least one of the cells constituting the fuel cell exceeds a second reference value.

For example, the controlling of whether to supply power to the fuel cell may include cutting off the supply of power to the fuel cell when a minimum voltage of all the cells constituting the fuel cell exceeds a third reference value.

For example, the controlling of whether to supply power to the fuel cell may include cutting off the supply of power to the fuel cell when an average voltage of the cells constituting the fuel cell exceeds a fourth reference value.

According to the fuel cell system and the method of controlling the same, it is possible to control whether to supply power to the fuel cell in order to comply with hydrogen emission regulations and to prevent excessive pressure from being applied to the anode space under a condition in which an excessive amount of hydrogen is present in the cathode space in the EHP reaction section. In addition, under a condition in which the amount of hydrogen is insufficient in the cathode space, it is possible to control the high potential phenomenon occurring during the hydrogen pumping process.

In addition, the hydrogen utilization rate and the concentration of hydrogen in the anode space are increased by pumping hydrogen. This makes it possible to reduce the number of times hydrogen is purged at the time of starting the fuel cell and to reduce the time required to start the fuel cell.

The effects obtained by the present disclosure are not limited to the aforementioned effects. Other effects, which are not mentioned above, should be clearly understood by those having ordinary skill in the art from the following description.

### BRIEF DESCRIPTION OF THE DRAWINGS

FIGS. 1 and 2 are views illustrating a power generation reaction and a hydrogen transfer reaction in a fuel cell according to an embodiment of the present disclosure.

FIG. 3 is a graph illustrating an anode/cathode hydrogen concentration progress according to a power generation stop time of the fuel cell.

FIG. 4 is a graph illustrating a progress of stack voltage monitor (SVM) according to high potential continuation when hydrogen is deficient in a cathode space.

FIG. 5 is a flowchart illustrating a control process in an excessive-hydrogen condition and a deficient-hydrogen condition in the cathode space according to the embodiment of the present disclosure.

FIG. 6 is a flowchart illustrating a control process of a fuel cell system, including states made before and after an electrochemical hydrogen pumping (EHP) reaction according to the embodiment of the present disclosure.

### DETAILED DESCRIPTION OF THE DISCLOSURE

Hereinafter, embodiments disclosed in the present specification are described in detail with reference to the accompanying drawings. The same or similar constituent elements are assigned with the same reference numerals regardless throughout the drawings, and the repetitive descriptions thereof have been omitted.

The suffixes “module”, “unit”, “part”, and “portion” used to describe constituent elements in the following description are used together or interchangeably in order to facilitate the description, but the suffixes themselves do not have distinguishable meanings or functions.

In the description of the embodiments disclosed in the present specification, the specific descriptions of publicly known related technologies have been omitted where it is determined that the specific descriptions may obscure the subject matter of the embodiments disclosed in the present specification. In addition, it should be interpreted that the accompanying drawings are provided only to allow those having ordinary skill in the art to easily understand the embodiments disclosed in the present specification. The technical spirit disclosed in the present specification is not limited by the accompanying drawings, and includes all alterations, equivalents, and alternatives that are included in the spirit and the technical scope of the present disclosure. The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as having different meanings in the context. When a component, device, element, or the like, of the present disclosure is described as having a purpose or performing an operation, function, or the like, the component, device, or element should be considered herein as being “configured to” meet that purpose or to perform that operation or function.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof. Such terms do not preclude the presence or addition of one or more other features, integers, steps, operations, elements, components, or combinations thereof.

In addition, the term “control unit” or “unit” included in the name of “motor control unit (MCU)” or “hybrid control unit (HCU)” is merely a term widely used to name a control device (controller or control unit) for controlling a particular vehicle function but does not mean a generic function unit. For example, the control unit may include a communication device configured to communicate with another control unit or a sensor to control a corresponding function. The control unit may include a memory configured to store an operating system, a logic command, and input/output information. The control unit may include one or more processors configured to perform determination, computation, decision, or the like required to control the corresponding function.

A fuel cell system, which may be applied to the embodiments, is described first before a method of controlling a fuel cell system according to the embodiments of the present disclosure is described.

A fuel cell generates power through a chemical reaction of hydrogen and oxygen. Specifically, a polymer electrolyte fuel cell (PEFC) is used as driving energy for a fuel cell electric vehicle (FCEV) driven by a motor.

The polymer electrolyte fuel cell is used in the form of a fuel cell stack made by assembling and stacking unit cells. The fuel cell stack has a structure in which tens or hundreds of unit cells are stacked repeatedly. The stacked unit cells are fastened by a clamping device to maintain an appropriate fastening pressure. The unit cell includes a membrane electrode assembly (MEA) in which electrodes having, as a main component, a catalyst layer in which an electrochemical reaction occurs are attached to two opposite sides of a polymer electrolyte membrane through which hydrogen ions (protons and H⁺) move. The unit cell also includes a gas diffusion layer (GDL) configured to evenly distribute reaction gases, a bipolar plate (BP) including passages through which the reaction gases and a coolant moves, and a gasket configured to ensure airtightness of the reaction gases and the coolant. The electrode includes a catalyst layer in which an electrochemical reaction occurs.

In particular, in the membrane electrode assembly (MEA) where a direct electrochemical reaction occurs, a pair of electrodes is disposed with the polymer electrolyte membranes interposed therebetween. Hydrogen, which is a fuel gas, is supplied to a hydrogen electrode (anode) occupying a predetermined volume inside the fuel cell. Oxygen-containing air, which is an oxidizing gas, is supplied to an air electrode (cathode).

The hydrogen supplied to the hydrogen electrode is decomposed into hydrogen ions (protons, H⁺) and electrons (e⁻) by a catalyst in the hydrogen electrode attached to one side of the polymer electrolyte membrane. Among them, only hydrogen ions selectively pass through the polymer electrolyte membrane, which is a cation exchange membrane, and move to the air electrode attached to the other side of the polymer electrolyte membrane. At the same time, the electrons are transferred to the air electrode through an outer conductive wire. A reaction formula of a chemical reaction inside the fuel cell is expressed as follows.

H₂→2H⁺+2e⁻ [Reaction in hydrogen electrode]

½*O₂(g)+2H⁺+2e⁻→H₂O(l) [Reaction in air electrode]

H2(g)+½*O₂(g)→H₂O(l)+Electrical energy+Thermal energy [Overall Reaction]

As expressed in the above reaction formulas, hydrogen molecules are decomposed in the anode into four hydrogen ions and four electrons. The electrons generate an electric current (electrical energy) by moving through an external circuit. The hydrogen ions move to the cathode through the electrolyte membrane to undergo a reduction electrode reaction. Water and heat are thereby produced as by-products of the electrochemical reactions.

The fuel cell may be connected to a drive system such as a motor, a high-voltage battery, and high-voltage operating devices (BOPs) through a main line. A voltage of the main line may be maintained as the same voltage as an output voltage of the fuel cell in a state in which the main line is connected to the fuel cell.

In addition, the fuel cell is connected to a chargeable/dischargeable power storage device. The power storage device may be charged with power generated by the fuel cell or supply power to the outside while discharging the charged power. Here, the power storage device may be a battery or a supercapacitor, and in one example may be a high-voltage battery (HV battery) or a low-voltage battery (LV battery).

In particular, a bi-directional high-voltage direct current to direct current (DC-DC) converter (BHDC) may be further provided between the chargeable/dischargeable high-voltage battery and the fuel cell.

In addition, the fuel cell system further includes: a fuel processing line (FPL) configured to supply and discharge hydrogen, which is fuel, to the fuel cell; an air processing line (APS) configured to supply and discharge oxygen-containing air, which is an oxidant, to the fuel cell; a thermal management line (TML) configured to perform a water management function inside the polymer electrolyte fuel cell by removing heat, which is a by-product of the fuel cell reaction, to the outside of the fuel cell system and adjusting an operating temperature of the fuel cell; and the operating devices (BOPs: Balance of Plants) configured to constitute the fuel processing line, the air processing line, and the thermal management line.

Examples of the high-voltage operating devices (BOPs) of the fuel cell system include a coolant stack pump (CSP), an air compressor (ACP), and a coolant heater (CHT), which are operated by a high-voltage source while passing through the bi-directional converter and being connected to the main line in the fuel cell or high-voltage battery.

In addition, low-voltage power devices (LV electronics) operated by a low-voltage source may be connected to a low-voltage line (LV-line), which connects a low-voltage battery (LV battery) and a low-voltage converter (LDC, a Low-voltage DC-DC Converter). The low-voltage battery may be provided for the normal operation of the low-voltage power devices and the operation of the controller. The low-voltage converter may be provided between the low-voltage battery and the bi-directional converter and connected to the low-voltage battery.

Unreacted hydrogen, moisture diffused into the hydrogen electrode, and nitrogen remaining in the air electrode are mixed with the post-reaction fuel gas, which is composed of nitrogen diffused from the air electrode to the hydrogen electrode through the polymer electrolyte membrane, and then supplied to the hydrogen electrode of the fuel cell. The unreacted hydrogen is hydrogen except hydrogen consumed by participating in the fuel cell reaction at the hydrogen electrode of the fuel cell among hydrogen which is a fuel supplied from a hydrogen storage device through a fuel recirculation device such as an ejector in the fuel processing line. The diffused moisture is moisture diffused into the hydrogen electrode among the moisture generated at the air electrode of the stack by the fuel cell reaction through the polymer electrolyte membrane. The nitrogen remains in the air electrode without participating in the fuel cell reaction among the air which is mainly composed of oxygen and nitrogen supplied to the air electrode of the stack through the air compressor.

In the process in which the fuel gas is circulated by the fuel recirculation device such as the ejector when the fuel gas is condensed into droplets, moisture of water present in the fuel processing line is collected into liquid water by a water trap (FWT). When the amount of liquid water is a predetermined amount or more, a drain valve (FDV) connected to the water trap changes from a closed state to an open state for a predetermined time. Thereby, the liquid of water is discharged to the air processing line and removed from the fuel processing line.

While the fuel cell is operating in the normal state, a purge valve (FPV) remains closed. As a result, as the amount of hydrogen consumed by the fuel cell reaction increases, the concentration of hydrogen present in the hydrogen electrode gradually decreases. When the concentration of hydrogen present in the hydrogen electrode decreases to a predetermined level or lower, a voltage at an output terminal of the fuel cell is lower than when the concentration of hydrogen present in the hydrogen electrode is at a predetermined level or higher under the same load condition. Therefore, new hydrogen may be introduced to the hydrogen electrode of the fuel cell in order to maintain the concentration of hydrogen present in the hydrogen electrode at a predetermined level or higher.

To this end, the purge valve (FPV) is changed from a closed state to an open state for a predetermined time. A part of the post-reaction fuel gas of the hydrogen electrode of the fuel cell is discharged to the air processing line and removed from the fuel processing line. New hydrogen, corresponding to the volume of the discharged post-reaction fuel gas, is introduced into the hydrogen electrode of the fuel cell.

The part of the post-reaction fuel gas discharged into the air processing line is mixed with post-reaction air and discharged to the outside. Here, the post-reaction air includes post-reaction oxygen, which excludes oxygen participating in the fuel cell reaction among air supplied to the air electrode of the fuel cell by the air compressor for the fuel cell reaction, nitrogen, and moisture of water, which is a by-product of the fuel cell reaction.

As described above, the excessive amount of air is supplied by the air compressor so that the hydrogen concentration of the gas discharged to the outside does not reach a level that threatens safety. In addition, the time for the purge valve (FPV) to remain open is reduced in proportion to the amount of air supplied by the air supply device. Thus, even though a part of the post-reaction fuel gas discharged into the air processing line is added, the concentration of hydrogen in the gas discharged to the outside does not reach the level that threatens safety.

In particular, the concentration of hydrogen at a level that threatens safety is regulated by law. For example, the hydrogen concentration regulated by the law may be a maximum of 8% and an average of 4% or less for 3 seconds.

In a stationary state in which the normal operation of generating power from fuel cells is ended, the air compressor stops running, and thus the introduction of air is stopped. As a result, the voltage in the stack decreases to a ground voltage level in a state that an air cut-off valve (ACV), the drain valve (FDV), and the purge valve (FPV) are closed. Thereby, a small amount of unreacted oxygen, nitrogen and water remain in the air electrode. In addition, after the air cut-off valve (ACV) is closed, the hydrogen supply valve (FSV) for supplying hydrogen to the hydrogen processing line may also be closed.

In a storage state in which the stationary state continues, the hydrogen electrode and the air electrode of the stack are stored to be electrically connected through a cathode oxygen depletion (COD) resistor 63. As a result, a small amount of unreacted oxygen present in the air electrode is completely removed. Simultaneously, hydrogen in the reaction gas present in the hydrogen electrode diffuses into the air electrode by crossover through the polymer electrolyte membrane and approaches equilibrium as the storage time increases.

In a restart process to bring the fuel cell back to normal operation so that the fuel cell generates power again, the air cut-off valve (ACV) is opened and the air compressor is operated to start to supply air to the air electrode of the fuel cell. In the process of raising the stack voltage while discharging, to the outside, the hydrogen that has been crossover through the polymer electrolyte membrane and diffused to the air electrode in the storage state, a section occurs, in which a small amount of hydrogen remaining in the air electrode in the stack and oxygen in the air supplied through the air compressor coexist. The larger the amount of air supplied to the air electrode in the stack through the compressor, the shorter the duration of this section.

In an FC Stop mode, the operation of the air compressor is stopped until a vehicle, which is turned on but stops in an idle state in which the power generation of the fuel cell temporarily is stopped, receives an acceleration signal, and restarts. However, in order for the fuel cell system to quickly respond to driving resumed by the vehicle, the vehicle is on standby with the air cut-off valve (ACV) open and with a predetermined level of stack voltage secured.

In particular, the FC Stop mode may be entered when a driving speed of the vehicle is a predetermined speed or lower or a required power of the fuel cell is a predetermined power or lower, and a state of charge (SOC) of the high voltage battery is a predetermined SOC or higher.

Even in the FC Stop mode, the hydrogen concentration in the air electrode is increased by the hydrogen crossover phenomenon in which the hydrogen in the hydrogen electrode diffuses to the air electrode through the polymer electrolyte membrane. In particular, in order to discharge the hydrogen in the air electrode to the outside so as to secure safety, the air compressor is operated at regular intervals for a predetermined time to repeatedly perform an operation of removing the hydrogen in the air electrode to the outside of the stack.

The discharge of reaction gas to the air electrode and the hydrogen electrode occupying a predetermined volume inside the vehicle fuel cell is achieved through the opening and closing of the air cut-off valve (ACV), the drain valve (FDV), and the purge valve (FPV).

In the normal state of the fuel cell, the hydrogen concentration of the gas discharged to the outside may satisfy the normal range when the fuel cell generates power or restarts after stopping. However, when a problem occurs in that a part of the polymer electrolyte membrane included in the fuel cell deteriorates or tears as the fuel cell is used for a long time, the amount of hydrogen crossover to the air electrode increases significantly. A problem occurs when the vehicle restarts or the FC Stop mode is released. The hydrogen concentration of the gas discharged to the outside is increased to a level that threatens safety.

To solve the aforementioned problems, the controller uses a method of reducing the concentration of hydrogen in the gas discharged to the outside by pumping hydrogen ions into the anode space through an electrochemical hydrogen pumping (EHP) reaction and recombining them into hydrogen molecules (H₂).

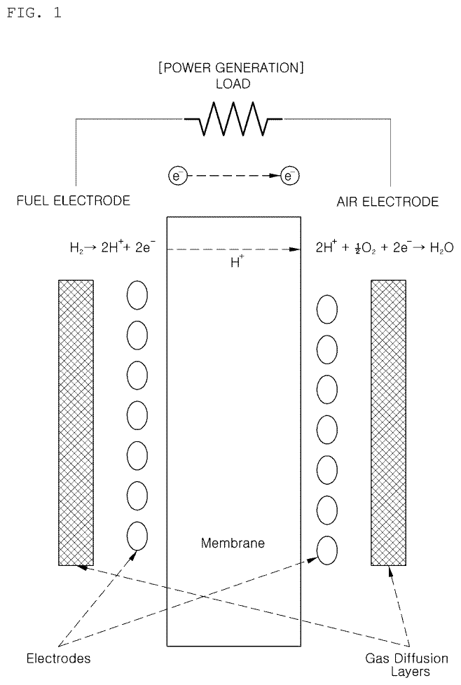

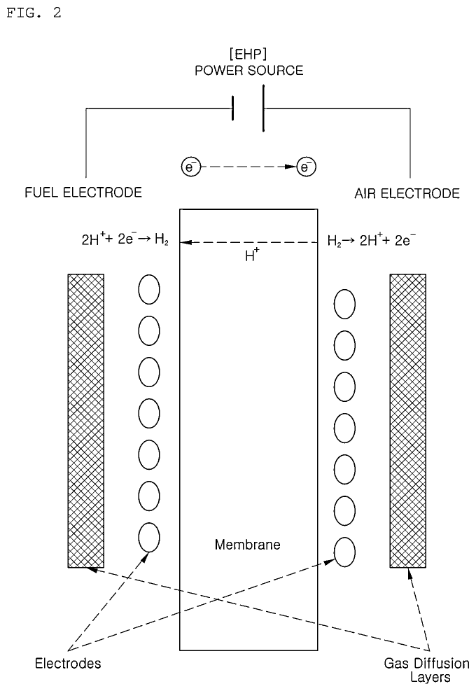

FIGS. 1 and 2 are views illustrating power generation and a hydrogen transfer reaction in a fuel cell according to the embodiment of the present disclosure.

Referring to FIGS. 1 and 2, hydrogen ions (protons and H⁺) generated during the oxidation of hydrogen in the cathode by energy supplied from the outside to the fuel cell move through the polymer electrolyte membrane and are then recombined into new molecular hydrogen. This reaction is called an electrochemical hydrogen pumping (EHP) reaction.

Specifically, since the fuel cell is a type of galvanic cell capable of flowing electricity and generating a voltage difference caused by the spontaneous oxidation-reduction (redox) reaction, the hydrogen electrode and the air electrode electrically appear to be alternatively polarized by the positive electrode (+) or the negative electrode (−).

There is no change in the electrical polarity of the hydrogen electrode and the air electrode of the polymer electrolyte fuel cell in the EHP reaction of FIG. 2 consuming power by power supply as well as the fuel cell reaction of FIG. 1 that generates power.

Because the polarities of the power components connected to the fuel cell do not change in either the fuel cell reaction or the EHP reaction, the components of a power net system of the fuel cell may be used without change.

However, just as the directions of current flow in charging and discharging for high-voltage batteries are opposite to each other in power generation that produces power and EHP that consumes power, there is a difference in that the directions of current flow for the fuel cell are opposite with respect to the directions of current flow between the fuel cell, the bi-directional converter, and the inverter. The polarity does not change even though the direction of current flow is reversed, in that the fuel cell serves as a power source in the case of power generation, and the fuel cell serves as a resistance by a separate power source in the case of EHP.

In addition, this amount of current is characterized by being reduced, after reaching a maximum value in the absence of moisture of water supplied from the outside of the fuel cell, by the feature of the polymer electrolyte fuel cell that the movement of hydrogen ions (protons and H⁺) is affected by the amount and distribution of moisture of water in the electrolyte membrane.

The electrochemical hydrogen pump (EHP) is proposed to comply with the emission regulations and risk of hydrogen combustion when residual hydrogen crossover on the cathode side is discharged in the form of exhaust hydrogen in the (re)start process. The electrochemical hydrogen pumps may utilize the characteristics of the polymer electrolyte fuel cell (PEMFC) capable of mutually converting chemical energy and electrical energy, as necessary. The PEMFC is mainly used in the form of a galvanic cell that converts the chemical energy of hydrogen into electrical energy. However, in some instances, it may be used in the form of an electrolytic cell that is converted into chemical energy when electrical energy is applied thereto.

In the EHP reaction, by applying a supply voltage, the residual hydrogen is oxidized and then separated into hydrogen ions (H⁺) and electrons in the cathode space that is the oxidation electrode. The hydrogen ions and the electrons move to the anode space which is the reduction electrode, through the electrolyte membrane and an external circuit, and are thus recombined into hydrogen molecules (H₂). In the present disclosure, this redox reaction is called hydrogen pumping, and a pumping output is regulated through a resistor embedded in a COD heater (CHT) of the EHP system.

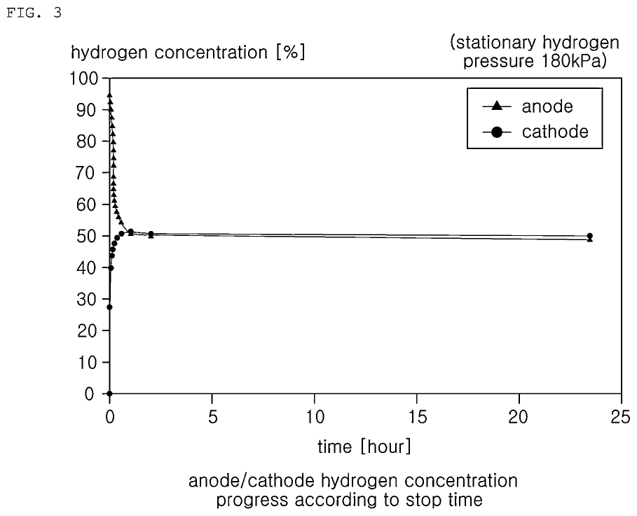

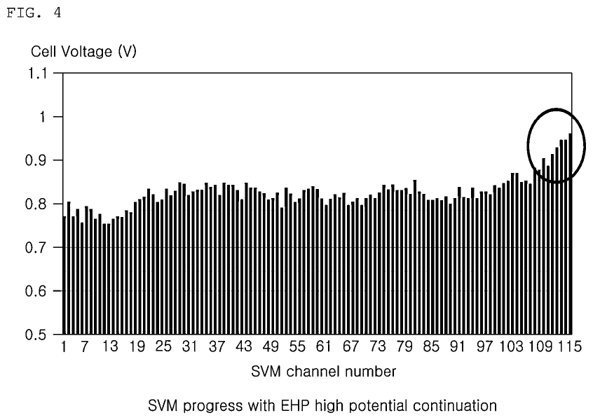

When the EHP function is operated, problems may occur depending on the cathode hydrogen condition. This is described with reference to FIGS. 3 and 4.

FIG. 3 is a graph illustrating the anode/cathode hydrogen concentration progress according to a power generation stop time of the fuel cell.

Referring to FIG. 3, the hydrogen concentration in the cathode space of the fuel cell increases rapidly for a short time of about 1 hour by crossover from the anode space immediately after the fuel cell power generation is stopped. The hydrogen concentration then gradually decreases after achieving hydrogen pressure equilibrium with the anode space. However, in an actual fuel cell system, the hydrogen concentration in the cathode space may be varied at all times by various factors such as an outside temperature, a coolant temperature, a stationary hydrogen pressure, and a degree of airtightness. In particular, even in the case in which a hydrogen concentration sensor is mounted in the cathode space, there is no hydrogen flow because of the characteristics of the system that is sealed when stopped, which makes it difficult to ensure the reliability of the sensor. The difficulty in estimating the concentration leads to the difficulty in setting the applied amount of EHP, and causes different problems, respectively, when the residual hydrogen in the cathode space is abundant and when it is deficient. When the residual hydrogen in the cathode space is abundant, there is a risk that the anode pressure may be increased excessively by the hydrogen pumping during the EHP reaction. In particular, during pumping in a situation in which the anode pressure is high, there is a risk that the design pressure of the anode space may be exceeded.

FIG. 4 is a graph illustrating the progress of SVM (Stack Voltage Monitor) according to the continuation of high potential when hydrogen is deficient in the cathode space.

Referring to FIG. 4, while hydrogen in the cathode space is deficient, when the output command continues in a state in which the redox reaction of hydrogen in the cathode space no longer occurs, the stack potential increases by the external supply potential. When high potential occurs, theoretically, if hydrogen does not exist in the cathode space, the flow current caused by the oxidation reaction of hydrogen may also be zero. However, residual hydrogen is always present because of the diffusion of residual hydrogen outside the interface and the crossover to the cathode space caused by the anode-cathode pressure difference increased by hydrogen pumping. Thereby, the high potential micro-current is continued. The cell voltage behavior has a relatively constant degree of distribution at the beginning of high potential generation. However, when the high potential continues, the cell deviation may gradually increase, leading to the cause of cell deterioration.

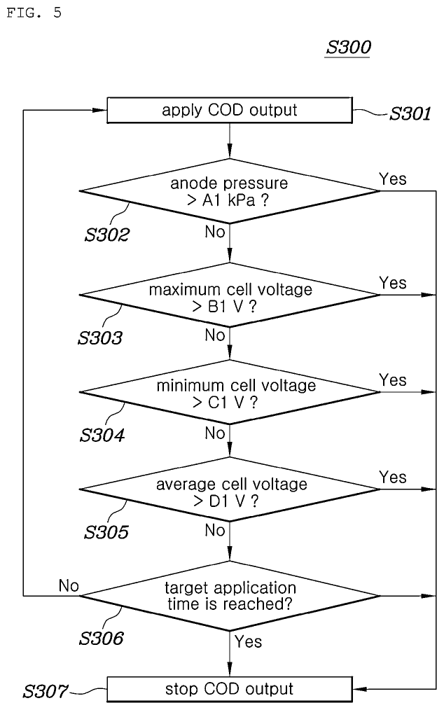

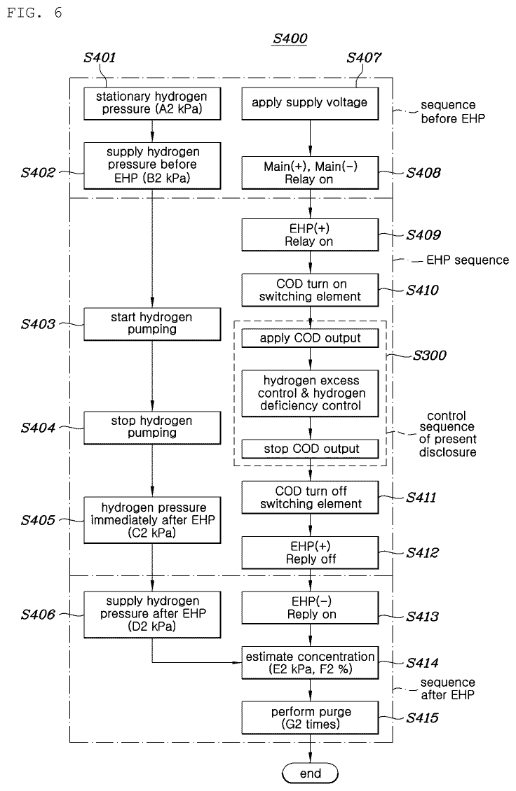

Based on the configuration of the above-described fuel cell system, a control method of the fuel cell system by the controller according to the embodiment of the present disclosure is described with reference to FIGS. 5 and 6.

The controller may measure the pressure in the anode space and the voltages of the cells constituting the fuel cell stack, based on which the controller may control whether to supply the power charged in the power storage device to the fuel cell. Here, the pressure in the anode space may be measured based on the gas concentration in the anode space. The higher the gas concentration in the anode space, the higher the pressure in the anode space is measured, based on which the controller may perform control to cut off the supply of power charged in the power storage device to the fuel cell. In addition, the voltages of the cells constituting the fuel cell may be measured based on the concentration of hydrogen in the cathode space. When the hydrogen concentration in the cathode space is rarefied, the controller may determine that the voltage of each cell constituting the fuel cell has a high potential, and thus may perform control to cut off the supply of power charged in the power storage device to the fuel cell.

FIG. 5 is a flowchart (S300) illustrating a control process in an excessive-hydrogen condition and a deficient-hydrogen condition in the cathode space according to the embodiment of the present disclosure.

First, the controller applies an output to the COD heater (CHT) of the EHP system to start the EHP reaction (S301). Thereafter, the controller may determine whether the pressure in the anode space exceeds a first reference value A1 (S302). The controller may perform control to cut off the supply of power to the fuel cell when the pressure in the anode space exceeds the first reference value A1. The controller may perform control to cut off the supply of power to the fuel cell when the pressure in the anode space exceeds the first reference value A1 (YES in S302) (S307). When the pressure in the anode space does not exceed the first reference value A1 (NO in S302), the controller may determine the following condition. When hydrogen pumping is performed through the EHP, hydrogen in the form of hydrogen ions passes through the electrolyte membrane and is recombined into hydrogen in the anode. Therefore, the pressure in the cathode space decreases, and at the same time, the pressure in the anode space increases. The controller may forcibly end the EHP by performing a COD output stop sequence at the moment when the pressure in the anode space exceeds the first reference value (A1) measured in Kilopascal (kPa). Here, the first reference value A1 needs to be lower than the designed pressure of the anode space and needs to be set to a value that may allow the hydrogen pumping to be smoothly performed.

Thereafter, the controller may determine a maximum voltage of each cell constituting the fuel cell and may determine whether the maximum voltage of at least one cell exceeds a second reference value B1 (S303). The controller may perform control to cut off the supply of power to the fuel cell when the maximum voltage of at least one cell exceeds the second reference value B1 (YES in S303) (S307). When the second reference value B1 is not exceeded (NO in S303), the controller may determine the following condition.

Maximum cell voltage-based control performed on the fuel cell is required to prevent the fuel cell from reaching the high potential section in which cell deterioration occurs. When any one of the cells exceeds the second reference value (B1) measured in volts (V), the COD output stop sequence is followed. In general, the cell deterioration occurs at about 0.85 V or more of the cell of the fuel cell. Accordingly, the second reference value B1 may be set to a value lower than 0.85 V.

Thereafter, the controller may determine a minimum voltage of all the cells constituting the fuel cell and determine whether the minimum voltage of all the cells exceeds a third reference value C1 (S304). The controller may perform control to cut off the supply to the fuel cell when the minimum voltage of all the cells exceeds the third reference value C1 (YES in S304) (S307). When the third reference value C1 is not exceeded (NO in S304), the controller may determine the following condition. Minimum voltage-based control performed on all the cells by the controller may be used to detect that hydrogen pumping has completely occurred and to stop the EHP within the shortest time. The configuration in which the minimum voltage of all the cells exceeds the third reference value C1 means that residual hydrogen is no longer present at the corresponding locations of all the cells. The third reference value C1 may be set to a value lower than the second reference value B1.

Thereafter, the controller may determine whether an average voltage of the cell constituting the fuel cell exceeds a fourth reference value D1 (S305). The controller controls that the supply to the fuel cell is cut off when the average voltage of the cells constituting the fuel cell exceeds the fourth reference value D1 (YES in S305) (S307). When the fourth reference value D1 is not exceeded (NO in S305), the controller may determine the following condition. Average voltage-based control performed on the cells constituting the fuel cell by the controller is a condition for protecting a limitation of the maximum cell voltage and minimum cell voltage control. The average voltage-based control does not correspond to two control conditions such as setting the second reference value B1 and the third reference value C1 high. However, the average voltage-based control may prevent a deterioration caused by an increase in voltage of all the cells of the fuel cell.

Thereafter, the controller may determine whether a target application time of the EHP reaction has been reached (S306). Because the control condition of the controller described above is configured as an OR condition, a case in which any one of the conditions is exceeded leads to forced termination of the EHP. Otherwise, the EHP is stopped after the target application time is reached (S307).

FIG. 6 is a flowchart (S400) illustrating a process of controlling a fuel cell system including states made before and after the EHP reaction according to the embodiment of the present disclosure. As illustrated in FIG. 6, the flowchart may be broadly divided into three parts, i.e., before the EHP, during the EHP reaction, and after the EHP.

The controller may perform control to supply hydrogen to the anode space based on an initial hydrogen pressure A2 in the anode space before the power generation of the fuel cell is stopped (S401, S402, and S407). The controller may perform control to supply hydrogen to the anode space when an initial hydrogen pressure (A2) in the anode space is lower than a supply hydrogen pressure B2 before the EHP. The hydrogen supply process may be omitted when the initial hydrogen pressure A2 in the anode space is higher than the supply hydrogen pressure B2 before the EHP. The reason why hydrogen is supplied to the anode space is to perform EHP under a constant hydrogen pressure condition. Thereafter, a fuel cell main relay may be supplied (S408).

In the EHP sequence, an EHP (+) relay and a COD switching element may be connected to form a circuit (S409 and S410). The hydrogen pumping speed and time may be set by adjusting the CHT resistor. As hydrogen pumping is performed (S403), the hydrogen pumping may be accompanied by a pressure drop in the cathode space and an increase in pressure in the anode space (B2 kPa->C2 kPa, S300, and S405). The amount of pressure change is made by the movement of hydrogen molecules. The deviation of the amount of pressure change may occur in accordance with hydrogen pressure, hydrogen concentration, and the like in the cathode space. When the above-described control condition S300 is satisfied, COD is stopped, and the COD switching element and relay are released in reverse order, which ends the EHP sequence (S404, S411, S412).

Thereafter, the controller may perform control to supply hydrogen to the anode space based on a hydrogen pressure C2 in the anode space made immediately after cutting off the supply of power to the fuel cell (S413). Here, hydrogen may be additionally supplied to the anode space after the EHP (S406). When a hydrogen pressure D2 required at the time of starting the fuel cell is higher than the hydrogen pressure C2 in the anode space, hydrogen is supplied by the difference in pressure. When the hydrogen pressure C2 in the anode space is higher than the hydrogen pressure D2 required at the time of starting the fuel cell, the hydrogen supply is not performed. Thereafter, a hydrogen concentration F2% in the anode space may be estimated based on the ideal gas equation (n=PV/RT) (S414) with the variables corresponding to molarity (n), pressure (P), volume (V), and the universal gas constant (RT). F2 may be estimated by using [(a+b+c+d)/e]*100, and each variable is as follows:

a=number of moles of hydrogen in the anode at stationary (mol)=(A2)*(V/RT)*anode hydrogen concentration

b=Number of moles of hydrogen supplied before EHP=(B2−A2)*(V/RT)*100

c=Number of moles of hydrogen by EHP hydrogen pumping (mol)=(C2−B2)*(V/RT)*100

d=Number of moles of hydrogen supplied after EHP(D2−C2)*(V/RT)*100

e=Total number of moles of gas of the current anode (mol)=(E2)*(V/RT)*100

In the case of a, the anode hydrogen concentration value according to the stop time of FIG. 1 may be utilized. Also, b to d represent situations in which hydrogen is supplied to the anode in the pressure increase section, and the concentration of hydrogen may be assumed to be 100% for convenience. Further, e represents the total number of moles of gas, and the total number of moles of gas is calculated as 100%. A result value of each term is omitted when the result value is negative. Based on the result value, the number of times G2 of purges in the start section may be determined (S415). The EHP hydrogen pumping may reduce the number of times of purges in accordance with the increased concentration of hydrogen in the anode space.

As a result, according to the fuel cell system and the method of controlling the same according to the present disclosure, it is possible to control whether to supply power to the fuel cell in order to comply with hydrogen emission regulations and prevent excessive pressure from being applied to the anode space under a condition in which an excessive amount of hydrogen is present in the cathode space in the EHP reaction section. In addition, under a condition in which the amount of hydrogen is insufficient in the cathode space, it is possible to control the high potential phenomenon occurring during the hydrogen pumping process. In addition, the hydrogen utilization rate and the concentration of hydrogen in the anode space are increased by pumping hydrogen, which makes it possible to reduce the number of times of purges at the time of starting the fuel cell and reduce the time required to start the fuel cell.

A controller according to an embodiment of the present disclosure may be implemented by a non-volatile memory (not illustrated) configured to store an algorithm for controlling operations of various constituent elements in a vehicle or store data related to software commands for executing the algorithm. The controller may also be implemented by a processor (not illustrated) configured to perform the operations by using the data stored in the corresponding memory. In this case, the memory and the processor may be implemented as separate chips. Alternatively, the memory and the processor may be implemented as a single chip in which the memory and the processor are integrated. The processor may be configured in the form of one or more processors.

While the specific embodiments of the present disclosure have been illustrated and described, it should be understood by those having ordinary skill in the art that the present disclosure may be variously modified and changed without departing from the technical spirit of the present disclosure defined in the appended claims.

What is claimed is:

1. A fuel cell system comprising:
a fuel cell including a plurality of cells and configured to generate power through a reaction between hydrogen supplied to an anode space and oxygen supplied to a cathode space;
a power storage device configured to be charged with power generated by the fuel cell or discharged to supply power; and
a controller configured to
recirculate hydrogen, which has been diffused from the anode space to the cathode space, into the anode space by supplying power, which is charged in the power storage device, to the fuel cell in a state in which the power generation of the fuel cell is stopped, and
control whether to supply the power charged in the power storage device to the fuel cell based on a pressure measured in the anode space and voltages of the plurality of cells that constitute the fuel cell.

2. The fuel cell system of claim 1, wherein the controller measures a pressure in the anode space based on a concentration of gas in the anode space.

3. The fuel cell system of claim 2, wherein the controller is configured to cut off the supply of power to the fuel cell when the pressure in the anode space exceeds a first reference value.

4. The fuel cell system of claim 1, wherein the controller measures a voltage of at least one of the plurality of cells constituting the fuel cell based on a concentration of hydrogen in the cathode space.

5. The fuel cell system of claim 1, wherein the controller is configured to cut off the supply of power to the fuel cell when a maximum voltage of at least one of the plurality of cells constituting the fuel cell exceeds a second reference value.

6. The fuel cell system of claim 1, wherein the controller is configured to cut off the supply of power to the fuel cell when a minimum voltage of all of the plurality of cells constituting the fuel cell exceeds a third reference value.

7. The fuel cell system of claim 1, wherein the controller is configured to cut off the supply of power to the fuel cell when an average voltage of the plurality of cells constituting the fuel cell exceeds a fourth reference value.

8. The fuel cell system of claim 1, wherein the controller is configured to supply hydrogen to the anode space based on an initial hydrogen pressure in the anode space before the power generation of the fuel cell is stopped.

9. The fuel cell system of claim 1, wherein the controller is configured to supply hydrogen to the anode space based on a hydrogen pressure in the anode space immediately after the supply of power to the fuel cell is cut off.

10. The fuel cell system of claim 1,
wherein the controller measures a concentration of hydrogen in the anode space based on the number of moles of hydrogen recirculated in the anode space, the initial number of moles of hydrogen in the anode space, and the number of moles of hydrogen supplied in the anode space before the power generation of the fuel cell is stopped and after the supply of power to the fuel cell is cut off, and
wherein the controller determines the number of times hydrogen is purged based on the measured concentration of hydrogen in the anode space.

11. A method of controlling a fuel cell system comprising
a fuel cell having a plurality of cells and configured to generate power through a reaction between hydrogen supplied to an anode space and oxygen supplied to a cathode space, and
a power storage device configured to be charged with power generated by the fuel cell or discharged to supply power, the method comprising:
supplying, by a controller, power charged in the power storage device to the fuel cell in a state in which the power generation of the fuel cell is stopped;
recirculating, by the controller, hydrogen, which has been diffused from the anode space to the cathode space, into the anode space; and
controlling, by the controller, whether to supply power charged in the power storage device to the fuel cell based on a pressure in the anode space and voltages of the plurality of cells that constitute the fuel cell.

12. The method of claim 11, wherein the controlling of whether to supply power to the fuel cell comprises cutting off the supply of power to the fuel cell when a pressure in the anode space exceeds a first reference value.

13. The method of claim 11, wherein the controlling of whether to supply power to the fuel cell comprises cutting off the supply of power to the fuel cell when a maximum voltage of at least one of the plurality of cells constituting the fuel cell exceeds a second reference value.

14. The method of claim 11, wherein the controlling of whether to supply power to the fuel cell comprises cutting off the supply of power to the fuel cell when a minimum voltage of all the plurality of cells constituting the fuel cell exceeds a third reference value.

15. The method of claim 11, wherein the controlling of whether to supply power to the fuel cell comprises cutting off the supply of power to the fuel cell when an average voltage of the plurality of cells constituting the fuel cell exceeds a fourth reference value.
